(19) United States
(12) Patent Application Publication
(10) Pub. No.: US 2002/0125712 A1
(43) Pub. Date: Sep. 12, 2002

(54) Technique for reducing the vertical dimension of compact paging format

(76) Inventor: Lyle Ely Felderman, Brea, CA (US)

Correspondence Address: LYLE ELY FELDERMAN, 681 WOOD LAKE DRIVE, BREA, CA, 92821, US

(21) Appl. No.: 09/798,134

(22) Filed: Mar. 5, 2001

(51) Int. Cl. G09B 29/00

(52) U.S. Cl. 283/34

(57) ABSTRACT

A large rectangular map, or chart, that is reduced to small and uniformly-sized display areas, in two or more vertical sections, having leaves in each section for easy directional leafing (right to left, left to right, up tab, down tab) to all selected display areas. There is no folding or unfolding. This leafing format is made possible by simply making folds for four or more even-numbered panels in the vertical dimension (first fold inward, outward, inward, etc.), slitting the horizontal outer folds between the right and left edge panels, fanfolding lengthwise into an odd number of vertical creases that form a vertical strip of the eight right edge panels, vertically fanfolding this strip into a tab, or tabs, overlaying them upon the bottom two panels, and abutting the four corner panels to create the base map paging format of four panel display pages. A foldable cover is required to anchor the format for permanency, stability, and storage. The size of the display pages and the folded cover can be controlled by the number of vertical folds lengthwise; more odd number of folds produce a smaller map; less folds a larger map. Likewise, the size of the display pages and folded cover can be controlled by the number of odd-number horizontal folds in a vertical dimension. Current maps are generally machine folded for storage; fanfolded lengthwise and two-folded vertically. They require unfolding and refolding. Many have covers only for presentability. This invention contains convenient features for use in small areas as: no unfolding and refolding, ease in opening for use, ease in closing for storage, ease in paging to all map areas, and mobility for changing viewing angles.

### CROSS REFERENCES TO RELATED APPLICATIONS—U.S. Patents

5,207,457—May 4, 1993—R. J. Haynes

3,143,363—Aug. 4, 1964—G. Falk

4,270,773—Jun. 2, 1981—R. Gaetano

4,906,024—Mar. 6, 1990—U. Lein

2,179,172—Nov. 7, 1939—C. Bonnaire

680,350—Aug. 13, 1901—S. Parmelee

5,868,429—Feb. 9, 1999—D. Raymond

1,159,459—Nov. 9, 1915—W. Wood

53062—Apr. 26, 1937—P. Arentzen (Denmark Patent)

### STATEMENT REGARDING FEDERALLY SPONSORED RESEARCH OR DEVELOPMENT Not applicable

### REFERENCE TO A MICROFICHE APPENDIX Not Applicable

### BACKGROUND OF THE INVENTION

1. Field of the Invention

This application adds two improvements to Pat. No. 6,189,933 issued Feb. 20, 2001.

a. Further reducing the vertical dimension of a map or chart. Paragraphs 1. Dimensioning and 3. Vertical Dimensioning Folds are modified slightly to incorporate this improvement.

b. Keeping pages from overlapping any border strip of index codes (incorporated in added Paragraph 1.Dimensioning, a. Patent 6,189,933 Paragraphs, Detailed Description of the Invention, 1.Dimensioning and 4. Vertical Dimension Folds, provide for only four evenly-numbered panels in the vertical dimension that make one outer fold that allows one slit to create one tab which permits paging. This tab in the vertical dimension is only required for the paging format to work. This application now provides that the same fanfolding requirements apply for both the vertical and horizontal folding, namely, four or more panels in either dimension, one or more outer folds, and one or more slits in the vertical dimension to create one or more tabs. The intent of this provision is to permit more tabs than the one required tab, which will further reduce the vertical dimension of the cover. The Detailed Description of the Invention Paragraphs 1.Dimensioning and 3.Vertical Dimension Folds, the Abstract of Disclosure, and the Claims Paragraphs A, B, and D of the original patent have been modified slightly to include this improvement.

Revised Drawings, FIGS. 1, 3, 4, 5, 6, and 7 are submitted with this application to show, as an example, the above improvement as having six vertical even- numbered panels with two slits that form two outer folds and two tabs to further reduce the cover's vertical dimension.

Most maps (highway, aviation, etc.) and other charts are too large for ready reference in a small area, as in a car or airplane. In general, they come fanfolded vertically onto their left or right edge and then folded twice from top to bottom into a storage format. As a quicker, immediately ready, and safer alternative for use, this invention folds a map in a uniquely simple manner into a small, more convenient, uniform, and flat display area with leaves to more quickly leaf to all map display areas. A cover must be adhered to provide a permanent stabile format and for closing to a compact storage format.

2. Review of the Prior Art

None of the listed cross-referenced patents match the descriptions of this titled application for the unique continuous folding of a map into a base uniform four-panel display and paging configuration necessary for economical assembly. Also, none specify slits for folding a map into two or more vertical sections in order to reduce the display and cover dimensions, the requirement for a cover to permanently fix the paging configuration, or drawings that show any likeness or similarity to the complete folding procedure of this patent application. These inventions contain complex descriptions as to folding, making multiple slits, and attaching covers to get a display area configuration for paging. Some of the patents contain systematic viewing procedures, non-uniformly sized viewing areas, provisions for unfolding and refolding, and lamination, none of which are included as claims for this titled specification. This titled invention is alone in claiming to fold a map in one continuous simple folding procedure to its display and paging configuration, and a cover to permanently fix the configuration.

### BRIEF SUMMARY OF THE INVENTION

The basic principle on which the paging format functions is that a selected number of inward and outward folds are made in the map both horizontally and vertically to produce creases for a selected number of rectangular panels. The map's display face is then fanfolded to the left with the right edge panels remaining open, resulting in a vertical strip of six or more right-most panels. This folding also adjoins the right edge panels with the left edge panels. This strip is folded once vertically to adjoin the four corner panels which results in the base of the paging format and the initial display page. The inside panels become leaves with their central veins centered at the fold line between the two right side panels and two left side panels. One or more slits along the horizontal outer folds between the left and right edge panels enable the folds to create two or more sections of the map in the vertical dimension, each with independent leaves for paging, and horizontal tabs for accessing each section. The sections are accessed by raising or lowering the horizontal tabs. The map now has its initial four-panel viewing format consisting of the top section's right-most four panels which, as shown in the map Figures, are equivalent to 1/12^{th} or 8.3% of the unfolded map's area. A necessary wrap-around, or two-piece cover is adhered to the back side to permanently fix the display configuration. The inner panels, as pages, may now be leafed left and right to give a continuous view of the map's top section, tabbed to another section, and similarly leafed to view.

### BRIEF DESCRIPTION OF THE SEVERAL VIEWS OF THE DRAWINGS

FIG. 1 is a plan view of a map showing a planned number of inward and outward folds for completion of the folding process.

FIG. 2 is a perspective of the horizontal dimension of the map showing the folding necessary for creating the creases for its leaves.

FIG. 3 is a perspective of a map having two outward folds in its vertical dimension that provide for two tabs that divide the vertical dimension into three sections to reduce the maps vertical cover dimension.

FIG. 4 is a perspective showing the fanfolding for a map having two slits that creates leaves and shows how they overlay upon the left edge panels.

FIG. 5 is a plan view showing the leaves with two slits that overlay upon the left edge panels with the right edge panels remaining open.

FIG. 6 is a perspective showing how two tabs with two slits are formed from the plan view position of FIG. 5.

FIG. 7 is a perspective showing how the top and bottom panels become adjacent after forming two horizontal tabs.

FIG. 8 is a perspective showing the horizontal tab overlayed upon the bottom panels to become the four-panel base of the map's paging format.

FIG. 9 is a perspective of the non-display back side of the FIG. 8 display format after it was turned 180 degrees and which shows placement of tape to anchor the folds.

FIG. 10 is a perspective showing the position for applying a wrap-around cover with adhesive.

FIG. 11 is a perspective, similar to FIG. 8, with the addition of a cover that shows the open cover display area that is ready for paging.

### DETAILED DESCRIPTION OF THE INVENTION

To understand how the paging format process is achieved five processes are performed: Dimensioning, Horizontal Dimension Folds, Vertical Dimension Folds, Page Folding, and Cover Application.

1. Dimensioning

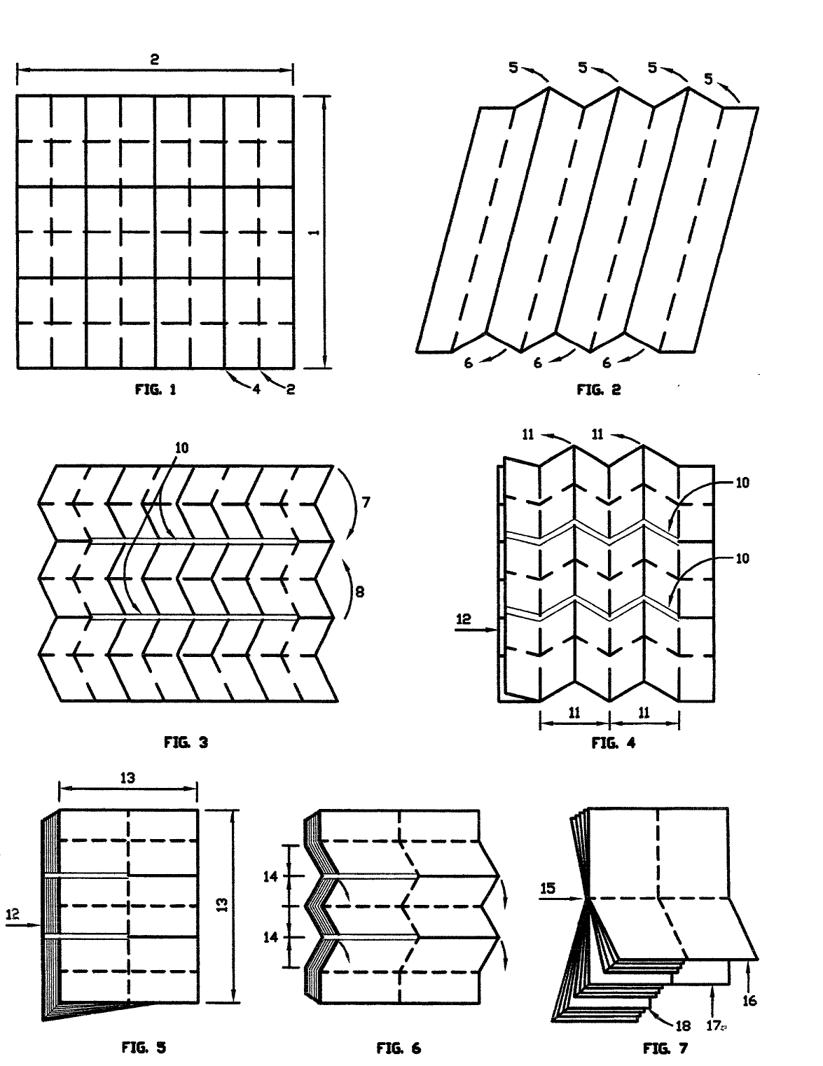

Place the map with its display face in view and with its longest dimension in a horizontal position. For orientation during folding, this provides an upper edge, bottom edge, left edge, and right edge. If the top of the chart's display is on the upper edge the final cover configuration opens like a check book, pages leaf left and right as in a book, and the horizontal tabs are on the bottom edge. If the map's display top and the upper edge are not the same, place the map's display top on the right edge rather than the left edge in order to have the final configuration open as a book, leaf up and down as in a check book, and have a vertical tab along the right edge. First, divide the vertical dimension (Ref. 1, FIG. 1), between the upper and bottom edges, into four or more equally-spaced panels for two or more outer folds, allowing two or more slits, that will create two or more tabs which will reduce the map's vertical dimension in the page folding process. Divide the horizontal dimension (Ref. 2, FIG. 1), between the side edges, into an even number of equally-spaced panels, with a minimum of four. The map will be folded in both directions one time less than the number of panels selected, e.g., 9 folds for 10 panels. Just assure that the first and last folds in both directions are an inward fold and this will in turn assure that there are both a minimum number and even-number of panels to complete the final page folding process for assembly. In all Figures the dashed lines (Ref. 3, FIG. 1) indicate inward folds and the solid lines (Ref. 4, FIG. 1) outward folds. These lines are for dimensioning and folding reference only and not part of the map's folding or final display configurations. When the following folding procedures are complete for an example map of 48 panels as in FIG. 1, the two rightmost upper edge panels are the exact dimensions of the folded cover, 1/24^{th} or 4.14% of the entire map's area. Thus adding more horizontally and vertically dimensioned even-numbered panels will further reduce both dimensions of the folded map's cover.

a. Improvement to Keep Pages from Overlapping Vertical Border Index Codes. The above Dimensioning paragraph describes the folding necessary when there are no narrow strips of index codes, as numbers and/or letters, along the vertical and horizontal edges of the map. When these code strips are present, measure the horizontal dimension between the inside edge of the codes (strips) on the left side and the inside edge of the codes on the right. This dimension when divided by the total number of evenly spaced panels is the panel width. Measure the panel widths beginning at the inside edge of the left edge index codes strip. This makes the left and right edge panels slightly wider than all the paging panels so that the pages are inset when turned so as not to overlay the border codes strip. When adding two or more evenly numbered panels in the vertical dimension to reduce the vertical dimension of the folded map's cover, the middle tab pages will lack the horizontal index codes and will require that they be aligned with the correct adjacent page above or below in order to view their horizontal indexing codes on their top and bottom borders.

2. Horizontal Dimension Folds

With its display face in view, make an odd number of equally-spaced folds along the horizontal dimension of the map in a fanfold manner to obtain vertical creases, first inward (Ref. 5, FIG. 2) then outward (Ref. 6, FIG. 2) for the selected number of folds in accordance with FIG. 1. The folded panels between the left and right edge panels will become the leaves of the paging format and there will be an even number of panels.

3. Vertical Dimension Folds

With its display face in view, fanfold along the vertical dimension, first inward (Ref. 7, FIG. 3), outward (Ref. 8), inward, etc. This folding results in all of the creases, five, for the planned number of panels per FIG. 1 and FIG. 3. Cut a slit (Ref. 10, FIG. 3.) along all of the horizontal outer fold creases, (two in FIG. 3) from the inside edge of the left edge panels to the inside edge of the right side panels. These slits will, in the following Page Folding process, create tabs that free the vertical leaves above and below the slits to be turned independently, and reduces the map's vertical cover measurement.

The key elements of the above improvement for further reducing the vertical format dimension are: fanfolding the creases; making more than four evenly-numbered panels by additional outward and inward creases for each additional section, or tab; slitting all horizontal creases between the inner edges of the left and right edge panels to create the pages for paging.

4. Page Folding

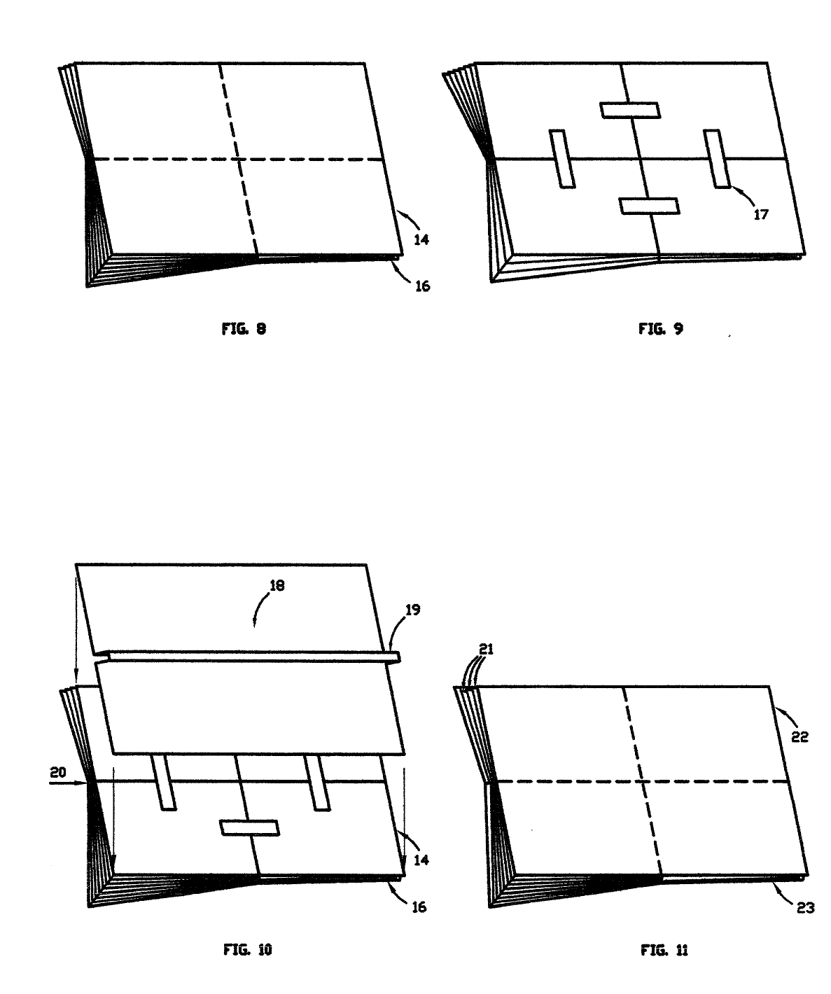

The above folds are used to configure the map paging format into two or more vertical sections, each containing the number of planned horizontal leaves (two in FIG. 3) in the Dimensioning process. To accomplish, fanfold to the left the horizontal folds (vertical creases) (Ref. 11, FIG. 4) and overlay the folded panels upon the left edge panels (Ref. 12, FIG. 4), leaving the right edge panels open (unfolded). The right and left edge panels are now adjacent and in view is a vertical strip of the twelve right edge panels (Ref. 13, FIG. 5). Fold together in a vertical direction the panels on each side of the slits on this vertical strip into two horizontal tabs, or leaves (Ref. 14, FIG. 6) which also moves the top edge panels adjacent to the bottom edge panels (Ref. 15, FIG. 7). This is the key map format position: all four corner panels touching. Move the tabs (Ref. 14, FIG. 8) down upon the lower edge panels (Ref. 16, FIG. 8) to display the initial viewing page of the map's top section, the map's four upper right corner panels. This configuration forms the base of the map's paging format (FIG. 8). A cover is applied with adhesive to fix this paging format permanently into this position for use as outlined below.

5. Cover Application

Rotate the assembly 180 degrees upward to the non-display back side of the map (FIG. 9). Shown is the non-display side of the folded map (FIG. 9) which contains the outward folds that determine the central veins for the pages on the display side. An adhered cover will permanently fix the paging format on the display side. Align the fold lines and anchor them in position with a small piece of tape across the folds (Ref. 17, FIG. 9). Dimension a wrap-around cover (Ref. 18, FIG. 10) including an expansion seam (Ref. 19) for the cover fold line to allow for expansion at the fold during map opening and paging. Apply adhesive to the back side of the map with none directly on the fold lines. Place the cover onto the map so that the cover's horizontal expansion seam (Ref. 19) matches the assembly's cover fold line (Ref. 20, FIG. 10). An option to the wrap-around cover is to use two pieces of card stock for the cover, allowing separation of the covers along the cover fold line for expansion at the fold during map opening and leaf turning. This two-piece cover provides the flexibility to bend the covers together, back to back, to further reduce the display area by 50% Rotate the assembly upward 180 degrees to the display side. If the map was folded with its upper edge and map display top coinciding, in view is the right four-panel display area of the top section. It opens like a check-book, and leafs left to right. Simply turn the leaves (Ref. 21, FIG. 11) left to right to view any four-panel display area in the top section that is contiguous to the features of the previous page. Raise one of the tabs (Ref. 22, FIG. 11) from the lower edge to the upper edge to view this section's display area (Ref. 23, FIG. 11). Turn the leaves to view this section. Align the corresponding pages of the top and next lower section to view its features that are contiguous along their boundaries. If the map was folded with its display top on the right edge, rotate it 114^{th} turn counter-clockwise and it will open like a book, leaf up and down, and tab right to left from section to section. There are openings between panels on the side borders of each map section and at the sliced ends of each leaf which can be joined with tape or adhesive to provide further rigidity and a more finished appearance. It is a desirable option but not necessary for the format to function. This function is more easily achieved when the map is in the FIG. 5 configuration.

Sequence Listing

Not applicable

I claim:

1. A map or chart with an upper edge, lower edge, left edge, right edge, a front surface display area of four panels of contiguous topographical or diagrammatic features, multiple leaves rooted between the vertical edge panels for accessing all other display locations, a cover to make permanent and stabile the leafing format and for folding for storage, said map comprising:
A. an odd number (3, 5, 7, etc.) of horizontal evenly-spaced folds that form four, or more, evenly-spaced panels, the first from the top an inward fold, the second an outward fold, etc., and an odd-number of vertical folds of three or more, alternately folded inwardly and outwardly to form double leaves between the single-leafed left and right edge panels, the resultant folds causing an even number of multiple panels, and
B. a slit along all the horizontal outer fold lines between the inner edges of the left and right edge panels which slits enable the map to be divided into two or more sections with leaves that can turn independently of each other, and
C. from the map's unfolded open position, fanfolded the vertical outer folds into leaves, overlayed them onto the left edge panels with the right edge panels remaining open, abutted the left and right edge panels, resulting in a two-panel wide strip of the right side panels, and
D. outward final folds at the horizontal slits to form a horizontal leaf, or leaves; to adjoin the inner edges of the four corner panels, to overlay the leaf, or leaves, upon the bottom panels, to position all leaves between the side panels along the vertical centerline, resulting in the base configuration for the map paging format and a display page of the top section's right-most four panels.

2. The map of claim 1, where adhesive tape is applied across the fold lines on the back side of the display configuration to permanently anchor their alignment; and adhering a wrap-around, or two-piece cover parallel to the back side's horizontal center fold line to provide a permanent and stabile paging format, and a foldable cover for storage.
